(19) United States
(12) Patent Application Publication
(10) Pub. No.: US 2024/0037937 A1
(43) Pub. Date: Feb. 1, 2024

(54) VEGETATION MANAGEMENT SYSTEM AND VEGETATION MANAGEMENT METHOD

(71) Applicant: Hitachi, Ltd., Tokyo (JP)

(72) Inventor: Tomonori YAMAMOTO, Tokyo (JP)

(73) Assignee: Hitachi, Ltd., Tokyo (JP)

(21) Appl. No.: 18/335,362

(22) Filed: Jun. 15, 2023

(30) Foreign Application Priority Data
Jul. 29, 2022 (JP) 2022-122026

(51) Int. Cl. G06V 20/10; G06Q 50/06; G06N 20/00

(52) U.S. Cl. CPC G06V 20/188; G06Q 50/06; G06N 20/00

(57) ABSTRACT

A sensing plan and a trimming plan in vegetation management are efficiently formulated. A vegetation management system includes: a data acquisition unit configured to acquire at least a satellite image of a power transmission line arrangement region; a site work situation collection unit configured to collect a situation of a trimming work executed at a site of the power transmission line arrangement region; and a planning unit configured to divide the power transmission line arrangement region into a plurality of partial regions, manage a status relating to the trimming work and the acquisition of the satellite image in association with each of the partial regions, and formulate a trimming work plan and a satellite image sensing plan based on the status. The status includes a non-shooting status, a shooting status, a clear waiting status, and a cleared status.

### BACKGROUND OF THE INVENTION

### 1. Field of the Invention

The present invention relates to a vegetation management system and a vegetation management method that use a satellite image.

### 2. Description of Related Art

In power transmission and distribution lines disposed mainly in a forested mountainous area, an accident such as wire breakage or fire may occur due to contact of vegetation, resulting in a power outage. As shown in FIG. 1, the contact of the vegetation with the power transmission and distribution lines includes a pattern in which a tree falls down due to an extremely bad weather or a disease, a pattern in which a branch or a trunk blown off is entangled, and a pattern in which a tree hangs onto the power transmission line as the tree grows. A short-term weather change is a main cause of falling down and blowing patterns, and long-term growth of the tree is a factor in the pattern in which the tree hangs onto the power transmission line as the tree grows.

Not only in Japan at which storm and flood damages occur frequently, but also in an area at which a forest is prone to fire in a dry weather, such as North America, vegetation management is being executed diligently. When a power outage occurs once, not only a recovery cost is high but also an opportunity to sell power during the power outage is lost. Therefore, the vegetation management around the power transmission and distribution lines is being executed diligently. A vegetation management method is also being digitized using a drone or a satellite image, and effects such as reduction in a patrol cost, prevention of overlooking, and quantification of work amounts and risks are expected.

From the viewpoint of risk quantification, PTL 1 discloses a method of creating a database for each tree and estimating a period in which a tree extends and comes into contact with a facility above the tree as a trimming period based on a height of the facility or the like, and a method of setting a scheduled trimming date and a trimming route based on the estimated tree trimming period, tree position information, and the like. Specifically, PTL 1 discloses that “A tree trimming period is known without patrolling trees in advance.” and that “A tree trimming instruction device 1 includes an input unit 2, a display unit 3, a processing unit 4, and a storage unit 5. A facility data update unit 42 of the processing unit 4 updates facility data 61 in the storage unit 5 when data related to facility change is acquired from the input unit 2. A tree data update unit 43 updates tree data 71 in the storage unit 5 when it is necessary to change the data due to the facility change or when data related to tree trimming is acquired from the input unit 2. A tree extension rate estimation unit 44 estimates a future tree extension rate for each tree species based on tree extension rate data 81 and weather data 91 in the storage unit 5. A trimming period estimation unit 45 estimates a period in which a tree extends and comes into contact with a facility above the tree as a trimming period based on the estimated tree extension rate, a height of the facility, and the like. A scheduled trimming date and trimming route setting unit 46 sets a scheduled trimming date and a trimming route based on the estimated tree trimming period, the tree position information, and the like.” A method using an aerial image such as a satellite image is being studied when the maintenance of the tree database itself is a difficult work and a wide geographical area is managed. In a remote sensing technique of shooting and analyzing an image from the sky, a technique of grasping macroscopic vegetation trends is also disclosed.

### CITATION LIST

### Patent Literature

PTL 1: JP2008-003855A

### SUMMARY OF THE INVENTION

When a technique of grasping a forest amount using an aerial image is combined with a method of grasping a vegetation growth risk and formulating a trimming plan, a trimming order can be planned at a glance by grasping the vegetation growth risk using the aerial image as shown in FIG. 2. However, it is expensive to acquire the aerial image itself and it takes time to shoot the aerial image, and a trimming plan may not be formulated while keeping all information on a forest area to be normally managed the latest.

A vegetation contact situation can be diagnosed from the sky using a paid high-resolution satellite image, but a range that can be shot in one shot is narrow, and a plurality of shots are required. A new sensing for a high-resolution satellite image is executed by an operation company requested to perform a sensing task when a cloud coverage rate, an elevation angle, and the like satisfy predetermined conditions for about two weeks. Therefore, it takes a lot of time to update the entire managed area to the latest.

The summer season in which a vegetation risk is maximized is an appropriate period for grasping a risk by shooting a satellite image, and is also a good time for trimming. There is a rainy season before the arrival of the summer season, and during the rainy season, both sensing and trimming stop. Since the start of an appropriate period of a satellite image sensing work and the start of an appropriate period of a trimming work overlap each other, it is necessary to simultaneously execute the satellite image-sensing work and the trimming work. When a trimming plan is formulated after the sensing of the satellite image is completed, it is possible to cut dispatch of a trimming worker to an unnecessary region, but when the trimming work is executed in a region during a new sensing task, a work of grasping a risk in advance by shooting an image is wasted. Since an actual current risk can be grasped in a region in which an image is shot, there is a possibility that there are places that need to be dealt with even if the trimming plan is changed.

When a sensing plan is formulated, a method of shooting a satellite image for confirmation referring to an evaluation result of a contact risk in the past is conceivable. Naturally, a prediction error is involved, and thus a method is needed to dynamically reflect, in the trimming plan, an actual vegetation risk sequentially determined by shooting an image of a part or the entire region.

As described above, when the vegetation management is performed, it is required to formulate a base plan without duplicating sensing and trimming, and to dynamically change the plan with respect to the sequentially determined current risk.

Therefore, an object of the present invention is to improve an efficiency of a sensing plan and a trimming plan in vegetation management.

In order to achieve the above-described object, one typical vegetation management system of the present invention is a vegetation management system for managing vegetation around a power transmission facility. The vegetation management system includes: a data acquisition unit configured to acquire at least a satellite image of a power transmission line arrangement region; a site work situation collection unit configured to collect a situation of a trimming work executed at a site of the power transmission line arrangement region; and a planning unit configured to divide the power transmission line arrangement region into a plurality of partial regions, manage a status relating to the trimming work and the acquisition of the satellite image in association with each of the partial regions, and formulate a trimming work plan and a satellite image sensing plan based on the status. The status includes a non-shooting status in which the satellite image is not shot, a shooting status in which the satellite image is waiting to be acquired, a clear waiting status in which it is evaluated that there is a risk necessary to be cleared by executing the trimming work, and a cleared status indicating that the risk is cleared regardless of whether the satellite image is shot. The planning unit acquires an order of executing the trimming work on the plurality of partial regions by training an agent, an action of the agent being along a direction of progress of handling a risk by trimming, with reinforcement learning based on statuses of the plurality of partial regions.

In addition, one typical vegetation management method of the present invention is a vegetation management method for managing vegetation around a power transmission facility. The vegetation management method includes: performing, by a vegetation management system, an acquisition step of acquiring at least a satellite image of a power transmission line arrangement region; a site work situation collection step of collecting a situation of a trimming work executed at a site of the power transmission line arrangement region; a planning step of dividing the power transmission line arrangement region into a plurality of partial regions, managing a status relating to a trimming work and the acquisition of the satellite image in association with each of the partial regions, and formulating a trimming work plan and a satellite image sensing plan based on the status; and an update step of updating the trimming work plan and the satellite image sensing plan by reflecting the situation of the trimming work executed at the site of the power transmission line arrangement region. The status includes a non-shooting status in which the satellite image is not shot, a shooting status in which the satellite image is waiting to be acquired, a clear waiting status in which it is evaluated that there is a risk necessary to be cleared by executing the trimming work, and a cleared status indicating that the risk is cleared regardless of whether the satellite image is shot. The planning step and the update step acquire an order of executing the trimming work on the plurality of partial regions by training an agent, an action of the agent being along a direction of progress of handling a risk by trimming, with reinforcement learning based on statuses of the plurality of partial regions.

According to the present invention, a sensing plan and a trimming plan in vegetation management can be efficiently formulated. Problems, configurations, and effects other than those described above will be clarified by the following description of an embodiment.

### BRIEF DESCRIPTION OF THE DRAWINGS

FIG. 1 is a diagram illustrating a contact problem of vegetation with power transmission and distribution lines;

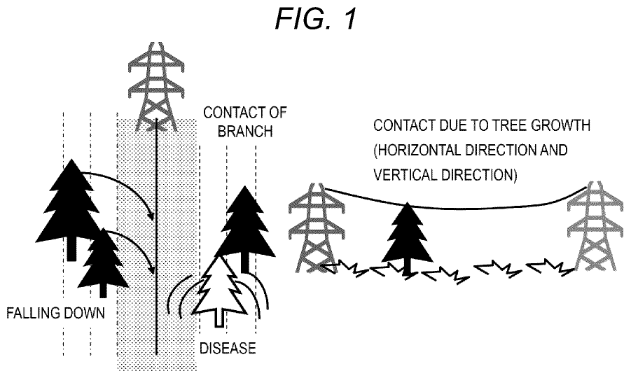

FIG. 2 is a diagram illustrating optimization of a trimming plan combined with aerial images;

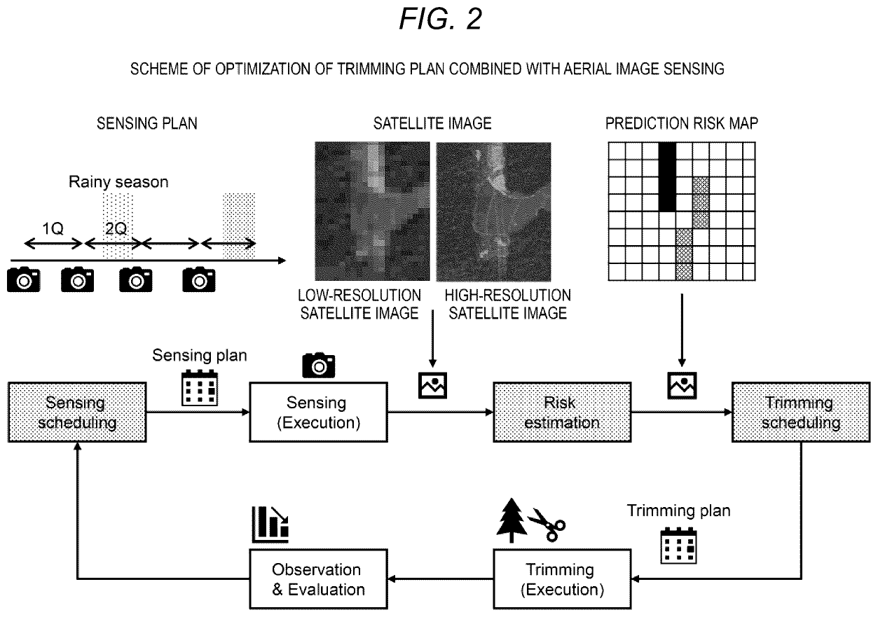

FIG. 3 is a diagram illustrating the whole of the present invention;

FIG. 4 is a diagram illustrating a method of cutting grids according to the present invention;

FIG. 5 is a diagram illustrating a method of formulating a sensing plan according to the present invention;

FIG. 6 is a schematic diagram of updating a sensing and trimming plan according to the present invention;

FIG. 7 is a diagram illustrating grid management according to the present invention;

FIG. 8 is a diagram illustrating an environment of reinforcement learning and reward setting according to the present invention;

FIG. 9 is a functional block diagram of the present invention;

FIG. 10 is a diagram illustrating a hardware configuration; and

FIG. 11 is a diagram illustrating a flow of performing the reinforcement learning by a trimming simulator.

### DESCRIPTION OF EMBODIMENTS

Embodiments of the present invention will be described by way of example. In the embodiment, a block, hardware, and processing with the same number basically perform the same operation, and thus a description thereof will be omitted.

### Embodiment 1

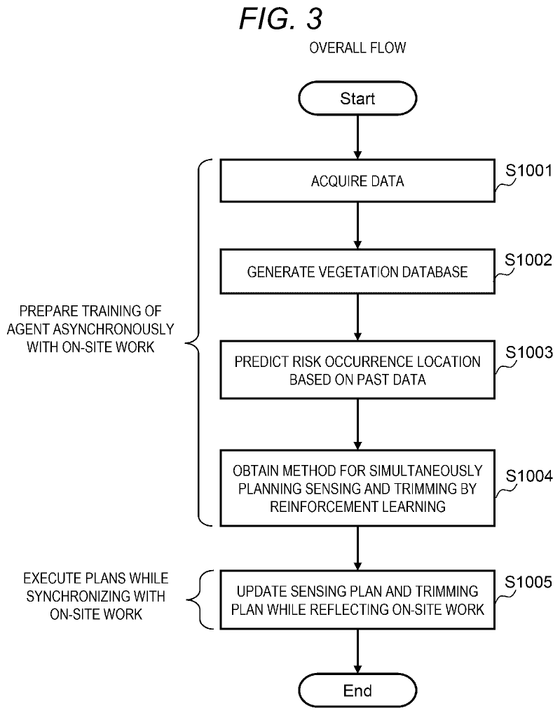

A flow of optimization of a trimming plan based on a shot satellite image of the present invention will be described with reference to FIG. 3. In the present embodiment, a main target is a long-term maintenance aimed at clearing a contact risk with a power transmission line due to the growth of vegetation. Since an overhead line height of the power transmission line is large and the vegetation grows slowly, there is a delay time of contact compared to a power distribution line, but once fire occurs, an influence range is wide. In North America or the like having a large land area, a region in which power transmission lines are disposed is wide. In order to reduce a risk of a power outage caused by vegetation, the entire region is periodically maintained. Since the power transmission line extends at a position higher than the power distribution line and the vegetation grows slowly, schedules are often set to maintain the region over several years.

A vegetation management system collects GIS data such as an aerial image, three-dimensional data, weather data, soil data, arrangement information on power transmission and distribution lines, and a past power outage place (S1001). Based on the data, the vegetation management system generates a database of vegetation around the power transmission line by executing an image processing (S1002). Information on the past power outage place macroscopically represents the ease of the power outage in the region.

Although it is difficult to normally keep the aerial image latest, if the aerial image is shot even once in the past, the vegetation management system predicts, based on the image, a weather, and soil data at the time, future growth and contact risks at a current timing and a future timing at which trimming is scheduled (S1003). The contact risks are created as a prediction risk map based on the image.

S1001 to S1003 in a flow may be prepared before a sensing plan, and may be asynchronous with the execution of the plan. The method of generating the prediction risk map is established by detecting the vegetation using the aerial image shot in the past and predicting a change in time series from the time point. The vegetation may be detected on a forest basis, and may be managed individually. When the vegetation is managed individually, data finer than that of a forest area is required. Only the forest area can be estimated with high accuracy by semantic segmentation or the like. When the vegetation is managed individually, an individual vegetation separation technique for detecting a tree crown by three-dimensional data or aerial images shot at a plurality of times is required.

If the tree crown can be detected once, it is possible to separate the tree into an individual tree species by extracting a spectrum value based on a center portion of the tree crown and collating the spectrum value with a plant spectrum library. There are several advantages in managing data on an individual tree basis as compared with a case in which a forest is managed on an area basis. For example, information on the tree species and information on a tree age can be managed. If the information on the tree species, the tree age, soil, and weather can be tracked, future growth can be accurately predicted, which leads to an accurate grasp of a vegetation contact risk.

When the contact risk is evaluated, the risk is the highest in summer, and thus a risk can be accurately predicted by shooting an image in summer. An image in winter is also considered to be useful for tree species classification if a falling leaf or a leaf color is detected, which is an auxiliary purpose, and a priority for shooting decreases after a tree species and a tree position are specified. Since summer arrives at the end of the rainy season, a trimming work is also easily executed, and it is assumed that a sensing work and the trimming work proceed at the same time. It is necessary to provide a method for avoiding duplicate trimming to prevent the sensing work from being wasted. The formulation of the sensing plan and the trimming plan based on the prediction risk map is acquired (S1004). In the system of the present invention, a method of formulating the sensing plan is acquired by performing reinforcement learning. A method of performing the reinforcement learning will be described later.

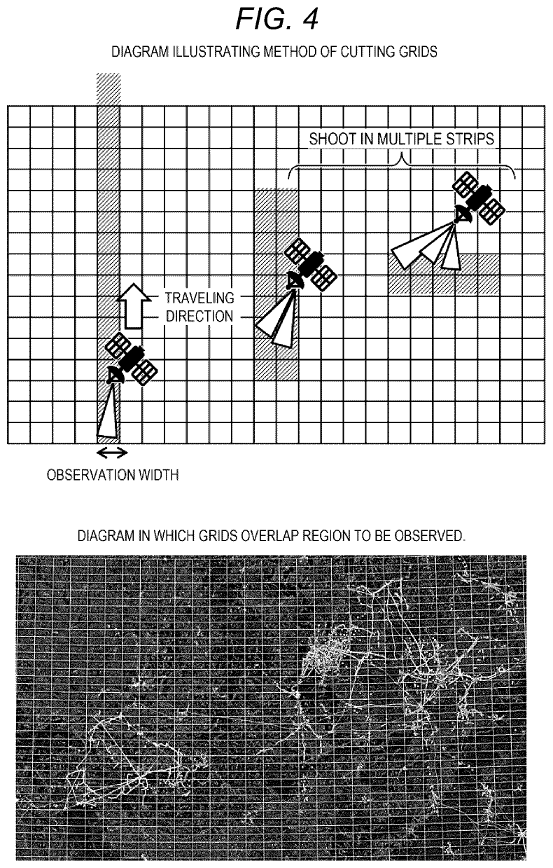

When the sensing plan is formulated, the sensing plan may be linked with a tasking method for a new satellite sensing. For example, as shown in FIG. 4, a new satellite image sensing is performed along the north-south direction. The new satellite image sensing depends on a satellite orbit, and grids may be created along an orbital direction of the satellite image to be used and managed. A size of the grid may be a size of one side, that is, an observation width (Swath) of the satellite. Alternatively, with the size of the grid as the maximum value, the width divided into a plurality of parts may be managed as the size of one side.

A satellite sensing mode includes a long-strip observation mode, a multi-strip wide-area observation mode, and a stereo observation mode. Since the long-strip observation mode in which a direct shooting is continuously performed has a high resolution and is suitable for a detailed determination of a contact risk, two-strip shooting or the like may be used in combination based on the long-strip observation mode in which the direct shooting is continuously performed. For each grid, a state of not shooting and an uncleared contact risk (unknown risk), a state of during shooting and an uncleared contact risk although determined in a plurality of stages (that is, clear waiting) and a state of being cleared regardless of the shooting state may be managed. When a state managed for each grid is given, the vegetation management system acquires, by performing the reinforcement learning, an action of an agent that executes an optimum action.

The vegetation management system of the present invention operates by using the acquired action guideline of the agent, receiving a progress report of an on-site work, synchronizing a risk clear situation with a shooting situation, and sequentially updating the sensing plan and the trimming plan at the same time (S1005).

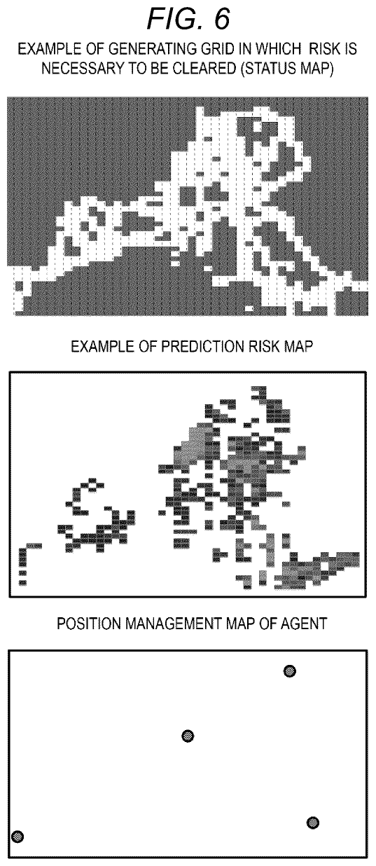

Since the reinforcement learning generally acquires an action by a simulation in which a situation is reproduced plural times, a trimming simulator is prepared. The trimming simulator generates observation spaces for, as shown in FIG. 6, a status map for managing a risk clear situation of the power transmission line, a prediction risk map, and a position management map for managing a position of a trimming agent.

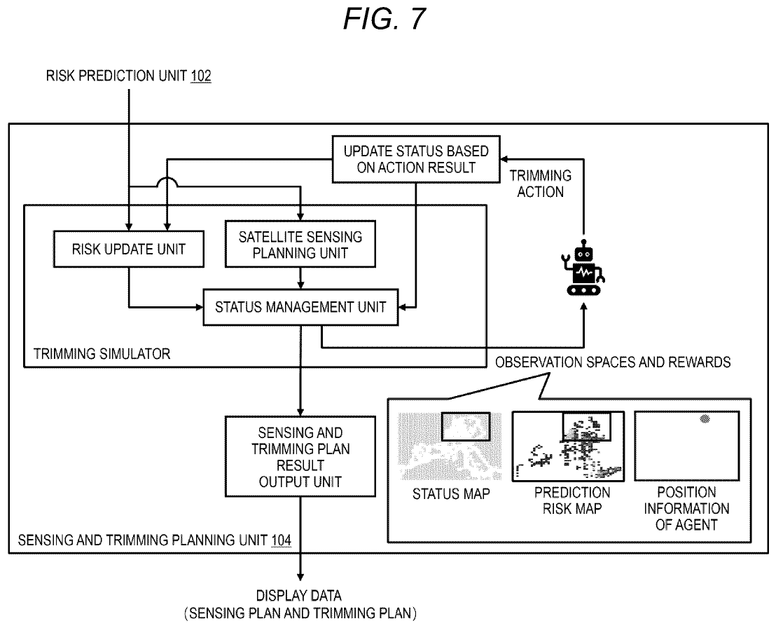

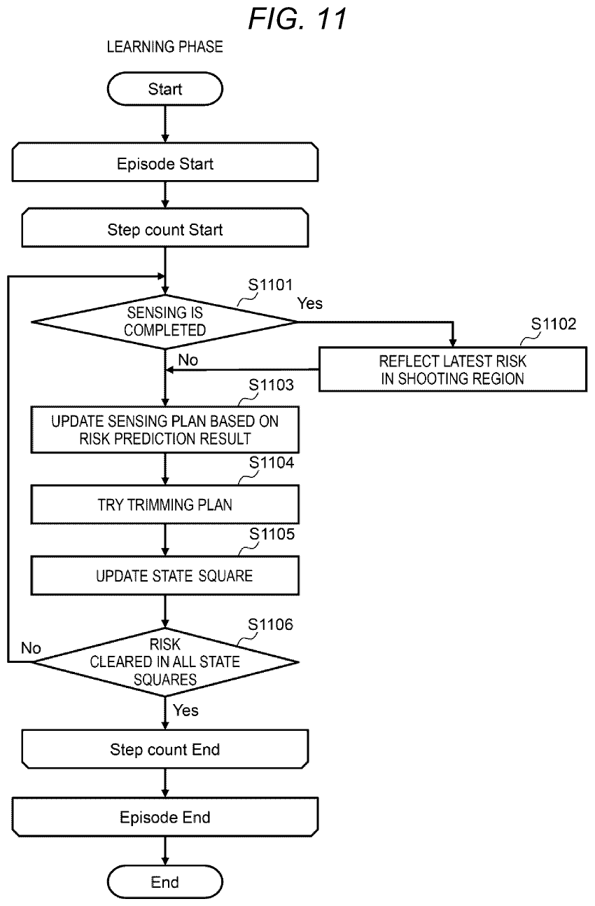

FIG. 7 is a diagram illustrating the trimming simulator. The trimming simulator implements one of functions of a sensing and trimming planning unit 104 to be described later. It is assumed that a satellite sensing planning unit in the trimming simulator performs substantially the same operation between an actual scene and the simulator. FIG. 11 shows a flow of performing the reinforcement learning by the trimming simulator. First, the trimming simulator performs a loop by determining the number of episodes to be used for performing the reinforcement learning and determining how many steps are to be moved in each episode. The step may be moved on a daily basis, and a unit time may be adjusted in accordance with a period taken to shoot a satellite image or an actual progress speed of work. In each step, the trimming simulator determines whether the new satellite sensing is completed (S1101).

The trimming simulator receives a satellite image when the new sensing is completed. A grid row for which shooting is completed once may be excluded from the sensing plan in the year. In a newly shot region, vegetation around a power transmission line is analyzed and retried with the prediction of the risk occurrence location as described in step S1003, and the prediction risk map is updated as needed (S1102).

Next, the trimming simulator updates the sensing plan based on a risk prediction result (S1103). The sensing plan is selected based on the prediction risk map, one row is selected along a traveling direction (north-south) of the satellite, and unchecked squares (grids) in the row are changed to a shooting status. Thereafter, the shooting status is maintained for about two weeks. Two weeks are assumed to be a task time of the new satellite sensing, and the number of weeks may differ depending on a specification of an ordered satellite. After the period ends, the trimming simulator updates the status map based on risk evaluation values obtained as image analysis results.

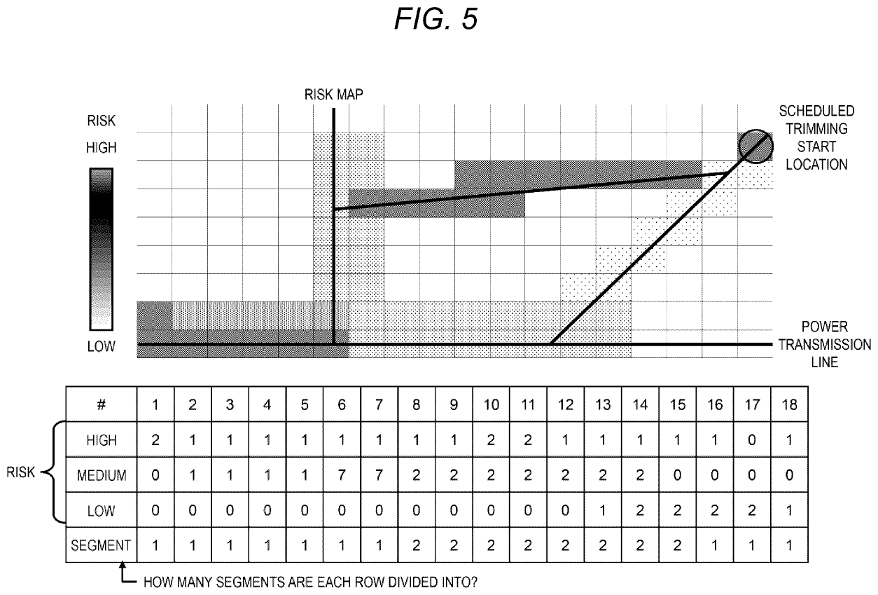

A method of assigning priorities to sensing plans will be described with reference to FIG. 5. Several methods are conceivable for assigning the priorities to sensing. Simply, the traveling direction of the satellite may be considered as a row direction, squares with a high contact risk may be aggregated based on the prediction risk map, and a row having plural squares determined to have a high risk may be preferentially shot. If the number of squares is the same, the number of squares with a medium risk and the number of squares with a low risk are counted, and a row with a large total number of squares is preferentially shot. When a trimming start location is known, sensing may be performed in a manner of being away from a position separated by a plurality of rows while avoiding duplicate sensing.

There are other methods of assigning priorities. A row having the largest number of grids in the clear waiting status may be prioritized. In addition, a row obtained by dividing blocks in which the clear waiting status is continuous may be prioritized. This is because the grids waiting to be cleared are divided into a plurality of blocks, and a trimming work is executed for each block, whereby the trimming work can be efficiently executed. In addition, in one shooting, a row including power transmission line squares divided into two segments may be prioritized. This is effective in a case of a policy in which, when the power transmission line branches in two directions, the shooting of squares of one power transmission line is first completed.

In conjunction with such features of the satellite image sensing, the trimming simulator acquires a trimming plan using the reinforcement learning (S1104). The trimming simulator defines a square that needs to be visited based on position information on an actual power transmission line by dividing a region in a grid shape, and the agent acquires a trimming action plan by performing the reinforcement learning. Although the sensing plan is based on risk information on vegetation growth predicted from past information, a method is needed to dynamically reflect, in the trimming plan, uncertainty due to a prediction error and an actual vegetation risk sequentially determined by new sensing. In order to handle this, the reinforcement learning is expected to effectively act.

As inputs, the agent observes three channels (status map, prediction risk map, and position information on agent) output from the trimming simulator as the observation spaces. The observation spaces of the three channels are given at one or a plurality of time points, and a reward is given to each action space that may be taken by the agent, thereby advancing learning. The action space of the agent refers to, for example, in which direction the agent moves in the grids, that is, a trimming progress direction. A discrete action space in which the agent moves up, down, left, and right may be simply defined. Of course, eight directions may be set so as to allow the agent to move diagonally. When a plurality of observation spaces are provided, an action space such as how many times a trimming action is continuously given in each traveling direction may be provided. A risk in a square stepped on by the agent is cleared, and is changed to cleared=CHECKED (value of state square: 0) on the status map.

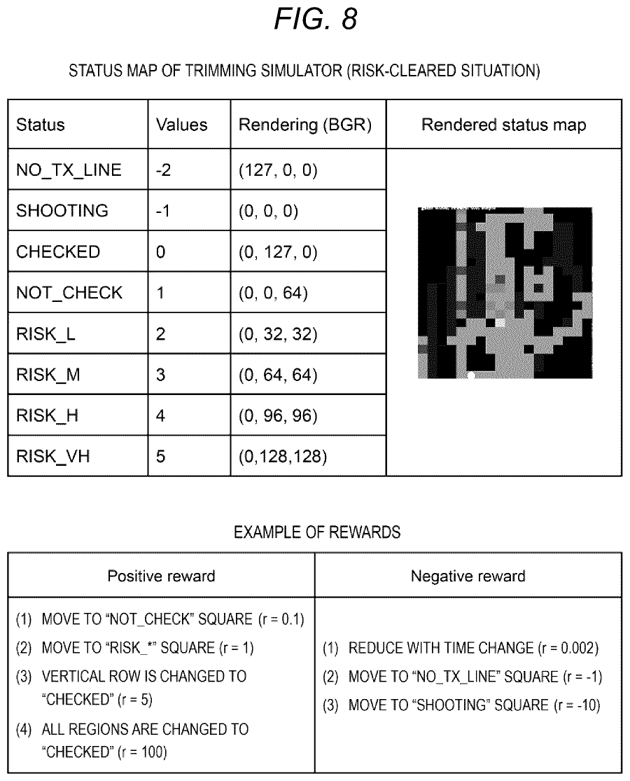

In the trimming simulator, time-series information is handled, and a map showing risk clear situations as shown in FIG. 8 is updated by reflecting the satellite sensing plan, a result thereof, and an execution result of the agent (S1105). The trimming simulator is intended to update every time on a daily basis.

A location to be visited by the trimming agent is set to be an uncleared and shooting incomplete region (NOT_CHECK) in an initial state. This is determined by position data of the power transmission line and an intersection determination of the grids divided according to a sensing orbit of a high-resolution satellite. A state of a region in which there is no power transmission line is given −2, a state of a shooting region is given −1, a state of a risk-cleared region is given 0, a state of the uncleared and shooting incomplete region is given 1, and states of places at which the new satellite image sensing is completed and immediate risks are determined are given 2 to 5, the states being classified according to risk stages. When it is determined that a risk evaluation value is lower than that of a low risk (RISK_L), that is, when it is determined that there is no risk, it may be considered that the risk is cleared without the need for the trimming agent to visit.

This is assumed to be controlled by a threshold of the risk evaluation value. In order to visualize the operation of the simulator, a graphic user interface may be prepared. The graphic user interface visualizes the status map by performing color rendering for each of the states and displays the status map together with the position management map of the trimming agent.

In the reinforcement learning, although it is necessary to acquire an action capable of responding to an event occurring in the future, the following measures may be taken because future ground truth data cannot be acquired. If a large number of satellite images are already available, a risk value is predicted based on a certain time point in the past, and an image that is newer than that in the past time point is regarded as a new image, whereby a method for reflecting an actual risk prediction value in training using information on an image available at the date and time is conceivable.

Alternatively, at the time of training, it is necessary to learn the future event on the premise that there is an error between an actual risk value obtained by analyzing a new shot image and a risk value predicted based on a past shot image. If a future risk prediction is perfect, the future risk can be predicted simply by executing a shooting order optimization plan, but an accuracy of a prediction algorithm is substantially not perfect, and thus there is uncertainty and it is necessary to consider the above-described error. In order to simulate the future risk, it is substituted by adding a predetermined amount of variation to the risk prediction value at the time of training.

That is, since information on the immediate risks determined by the new sensing deviates from values in the prediction risk map, a method for handling the deviation may be trained. In an execution phase of the plan, it is not necessary to add the above-described error to the prediction risk map.

An operation that the agent performs learning in a learning phase of the reinforcement learning strongly depends on a reward design. An object is to optimize a trimming order by cooperating with the satellite sensing, and for example, rewards as shown in FIG. 8 may be given. A negative reward is given when the agent passes through a place at which there is no power transmission line (NO_TX_LINE, value of state square: −2) or when the agent passes through a square during a sensing task (SHOOTING, value of state square: −1).

A reward is given when the agent visits the uncleared and shooting incomplete region (NOT_CHECK, value of state square: 1) and when the agent moves to the risk-determined squares (RISK_L, RISK_M, RISK_H, and RISK_VH, value of state square: 2 to 5). A method of dividing the risk-determined squares may have a mechanism capable of adjusting the number of divisions and a threshold parameter.

Although no new reward is generated when the agent passes through the CHECKED square in which the risk is already cleared, the number of times of passing through the duplicate place is reduced by providing a mechanism that reduces rewards over time. Since satellite sensing is performed in the north-south direction (row direction), it is desirable that a risk-cleared square is also filled in the row direction. This is because if all risks of squares in a certain row are cleared before performing the satellite sensing, the row does not need to be shot, which is advantageous in terms of cost as no shooting is required. Therefore, when all squares in a vertical row are changed to CHECKED, a slightly large reward value is given, and when all NOT_CHECK squares are changed to CHECKED, one episode of the reinforcement learning is completed, and a large reward is given (S1106). The reinforcement learning is performed such that a total reward obtained for each episode increases. No reward is given when a risk is diagnosed to be equal to or less than a predetermined value by shooting instead of the trimming agent, and automatically becomes CHECKED.

The agent performing the reinforcement learning learns one or both of a value base and a policy base. In order to manage the number of states proportional to the combination of the observation spaces and the action spaces, when a large space is handled, an approach of deep reinforcement learning in which a neural network is introduced is adopted. The approach starts with Deep Q-Network (DQN), which has a proven track record in interpersonal Go, and is advanced. As the observation spaces become wider, the calculation may be less likely to converge, and thus the reinforcement learning may be performed only in a region that can be physically managed in one year. A size of the observation spaces should be limited to the extent that the episode ends once in several hundred steps when the agent appropriately moves. The episode is repeated, and the processing ends when it is confirmed that a predetermined reward is obtained.

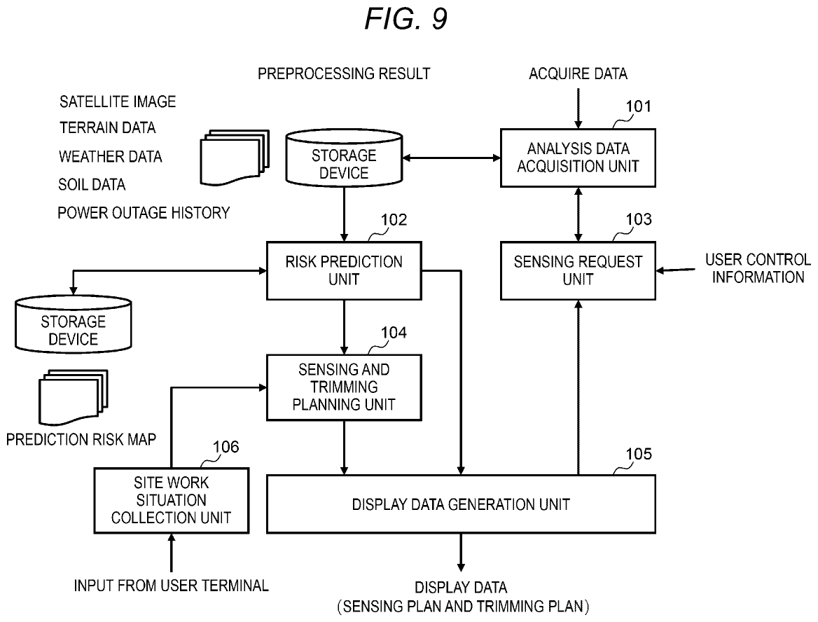

FIG. 9 is a functional block diagram for executing an actual sensing and trimming plan by the agent of the reinforcement learning obtained in the flow. The vegetation management system includes an analysis data acquisition unit 101, a risk prediction unit 102, a sensing request unit 103, the sensing and trimming planning unit 104, a display data generation unit 105, and a site work situation collection unit 106.

The analysis data acquisition unit 101 is in charge of actually acquiring a satellite image and downloading weather data, soil data, and terrain data to be used for growth prediction, a power outage history to be used for risk prediction, GIS data on a power transmission line position, and the like in conjunction with the sensing request unit 103.

The risk prediction unit 102 is in charge of processing for calculating risk evaluation values at each status map position. By inputting the data into the sensing and trimming planning unit 104, a trimming plan is output using a result of the reinforcement learning.

The trimming plan to be presented to a user is processed by the display data generation unit 105 which is an output unit, and presented as data on a patrol order for each grid or data on a patrol order for each line converted for each section of a power transmission line present in the grids.

Information on a site needs to be updated on time so that the trimming plan and the optimization plan can proceed simultaneously. For example, an application capable of uploading a site work situation or a standard electronic report document may be created, and information may be input every day by a trimming worker at the site. A function of receiving the input is implemented by the site work situation collection unit 106. The site work situation collection unit determines a work content reported by the worker, and provides information necessary for updating a situation for the sensing and trimming planning unit 104.

In an execution phase of a learning result, the sensing and trimming planning unit 104 outputs a next plan using a situation of the satellite sensing during tasking, a growth risk predicted based on past data, a work place of the trimming agent provided by the site work situation collection unit 106, and a risk clear situation, and provides the next plan to the display data generation unit 105.

As described with reference to FIG. 7, the sensing and trimming planning unit 104 includes the trimming simulator and a sensing and trimming plan result output unit. The trimming simulator includes a risk update unit, the satellite sensing planning unit, and a status update unit. The risk prediction unit 102 provides the risk prediction result to the risk update unit and the satellite sensing planning unit. In addition, a result of actions (movement and risk clear action) performed by the agent is input to the risk update unit and a status management unit.

The risk update unit updates the risk based on the risk prediction result and the action result, and outputs the risk to the status management unit. The satellite sensing planning unit formulates a satellite sensing plan based on the risk prediction result, and outputs the plan to the status management unit.

The status management unit updates the observation spaces (status map, prediction risk map, and position information on agent) using the updated risk, the satellite sensing plan, and the agent action result, and sets rewards. The agent performs next actions based on the updated observation spaces and the rewards.

In addition, the status management unit outputs the sensing plan and the trimming plan derived from the updated observation spaces to the sensing and trimming plan result output unit.

The sensing and trimming plan result output unit outputs the sensing plan and the trimming plan to the display data generation unit 105.

The display data generation unit 105 appropriately generates display data for the sensing plan and the trimming plan, and outputs the display data. Therefore, the user can confirm a trimming work plan formulated based on the sensing plan and the sensing plan formulated based on the trimming work plan.

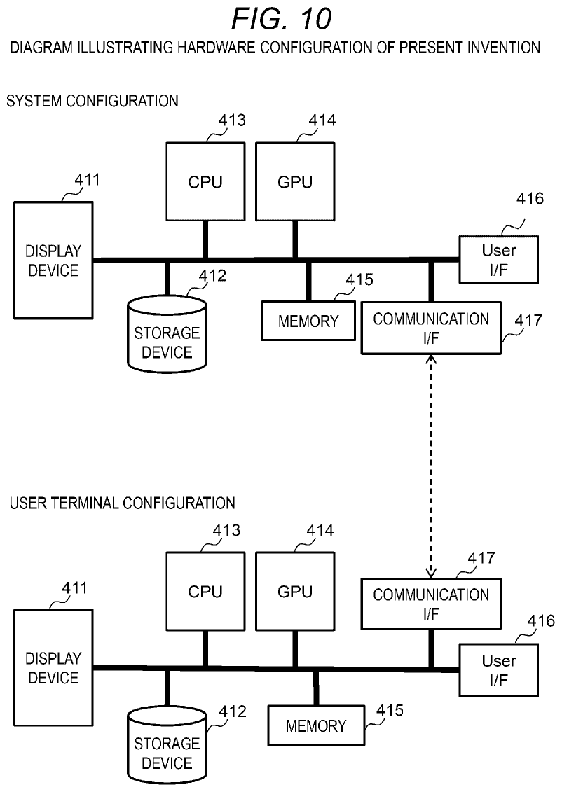

FIG. 10 shows a hardware configuration for implementing the present invention. A central processing unit (CPU) 413 activates a program of the present invention and executes processing of functional blocks in FIG. 9. Data to be used for calculation is temporarily stored in a memory 415. When high-speed calculation is required, the data may be transferred to a memory of a graphics processing unit (GPU) 414, and a calculation support of the GPU may be used. In particular, when the deep reinforcement learning is used, assistance with parallel calculation using the GPU may be received.

Output data of the trimming plan is displayed on the display device 411. The user may determine the trimming plan based on the displayed result, and may place an actual image order or the like through a user interface 416. Obtained data and the prediction risk map may be managed on a storage device 412. A communication interface may be used to implement a system with a plurality of computers or to execute an actual calculation processing in an instance on a cloud. A provision form of a server may be an on-premise server, or may be implemented on a public cloud. When the provision form is implemented in the public cloud, the CPU 413, the GPU 414, and the memory 415 may be dynamically secured and scaled according to a calculation scale. When using an external calculation resource, communication is performed by a communication I/F 417. Similarly, a user has terminal hardware including a computer. A progress situation in the on-site work is uploaded from a terminal via the communication I/F 417.

According to the above-described flow, a method of optimizing the trimming plan is provided.

As described above,
the vegetation management system of the disclosure is a vegetation management system for managing vegetation around a power transmission facility. The vegetation management system includes: the analysis data acquisition unit 101 as a data acquisition unit configured to acquire at least a satellite image of a power transmission line arrangement region; the site work situation collection unit 106 configured to collect a situation of a trimming work executed at a site of the power transmission line arrangement region; and the sensing and trimming planning unit 104 as a planning unit configured to divide the power transmission line arrangement region into a plurality of partial regions, manage a status relating to the trimming work and the acquisition of the satellite image in association with each of the partial regions, and formulate a trimming work plan and a satellite image sensing plan based on the status.

The status includes a non-shooting status in which the satellite image is not shot, a shooting status in which the satellite image is waiting to be acquired, a clear waiting status in which it is evaluated that there is a risk necessary to be cleared by executing the trimming work, and a cleared status indicating that the risk is cleared regardless of whether the satellite image is shot. The planning unit acquires an order of executing the trimming work on the plurality of partial regions by training an agent, an action of the agent being along a direction of progress of handling a risk by trimming, with reinforcement learning based on statuses of the plurality of partial regions.

With such a configuration and operation, a sensing plan and a trimming plan in a vegetation management can be efficiently formulated.

The partial region is a grid partitioned by an orbital direction of a satellite to be used for shooting the satellite image and a width direction orthogonal to the orbital direction, and a size of one grid in the width direction corresponds to an observation width of the satellite.

The planning unit performs the reinforcement learning by setting a reward with respect to a fact that all grids constituting a row in the orbital direction are in the cleared status before the grids are in the shooting status when the trimming work plan is formulated, and the planning unit excludes the row in which all the grids are cleared by executing the trimming work when the sensing plan is formulated.

Therefore, the sensing plan and the trimming plan can be formulated by effectively using a high-resolution satellite image.

The planning unit performs the reinforcement learning by setting a reward in accordance with a risk determined by analyzing a newly shot satellite image.

In addition, the reinforcement learning is performed by setting a penalty when the partial region in the shooting status and the partial region in which the trimming work is executed duplicate each other.

As described above, by appropriately setting the reward, it is possible to formulate the trimming plan in consideration of a relation with the satellite image sensing plan.

The vegetation management system may further include the risk prediction unit 102 configured to diagnose a contact risk, the contact risk being a risk that the vegetation comes into contact with the power transmission facility, by at least one of the number of times of occurrence of a power outage in the past or a satellite image shot in the past, and generate a prediction risk map in which growth over time is reflected in a risk evaluation result, and the planning unit may formulate the trimming work plan using the prediction risk map.

With the configuration, the sensing plan and the trimming plan can be formulated by effectively using past data.

The planning unit, when a satellite image that is a sensing result is obtained for the partial region in the shooting status, evaluates a risk in a plurality of stages based on the satellite image, and updates the partial region evaluated as having a risk necessary to be cleared by the trimming work to the clear waiting status.

With the configuration, a long-term and detailed trimming plan can be formulated according to the risk evaluated in the plurality of stages.

The planning unit may update the partial region with a sufficiently low risk to be in the cleared status.

With the configuration, the number of grids in which the trimming work is actually executed can be reduced, and the trimming work can be efficiently executed.

When the sensing plan is formulated, the planning unit may set a row having a largest number of grids with a high risk as a next new sensing candidate.

Alternatively, the planning unit may set a row having a largest number of grids in the clear waiting status as a next new sensing candidate.

Alternatively, the planning unit may formulate a plan in which a row obtained by dividing blocks in which the clear waiting status is continuous is set as a next new sensing candidate.

As described above, by using an appropriate index, it is possible to formulate the sensing plan in consideration of the relation with the satellite image sensing plan.

The planning unit may add an error component of a growth prediction model of the vegetation as a risk prediction error when simulating an actual risk determined by the satellite image during the reinforcement learning.

With the configuration, the risk can be predicted by effectively using the error of the growth prediction model.

The vegetation management system may further include the display data generation unit 105 as an output unit configured to output the trimming work plan formulated based on the sensing plan and the sensing plan formulated based on the trimming work plan.

With the configuration, the user can confirm the trimming plan and the sensing plan that affect each other.

The present invention is not limited to the above-described embodiment, and includes various modifications. For example, the above-described embodiment has been described in detail for easy understanding of the present invention, and the present invention is not necessarily limited to those including all configurations described above. In addition, the present invention is not limited to the deletion of such configurations, and replacement or addition of configurations is also possible.

What is claimed is:

1. A vegetation management system for managing vegetation around a power transmission facility, the vegetation management system comprising:
a data acquisition unit configured to acquire at least a satellite image of a power transmission line arrangement region;
a site work situation collection unit configured to collect a situation of a trimming work executed at a site of the power transmission line arrangement region; and
a planning unit configured to divide the power transmission line arrangement region into a plurality of partial regions, manage a status relating to the trimming work and the acquisition of the satellite image in association with each of the partial regions, and formulate a trimming work plan and a satellite image sensing plan based on the status, wherein
the status includes a non-shooting status in which the satellite image is not shot, a shooting status in which the satellite image is waiting to be acquired, a clear waiting status in which it is evaluated that there is a risk necessary to be cleared by executing the trimming work, and a cleared status indicating that the risk is cleared regardless of whether the satellite image is shot, and
the planning unit acquires an order of executing the trimming work on the plurality of partial regions by training an agent, an action of the agent being along a direction of progress of handling a risk by trimming, with reinforcement learning based on statuses of the plurality of partial regions.

2. The vegetation management system according to claim 1, wherein
the partial region is a grid partitioned by an orbital direction of a satellite to be used for shooting the satellite image and a width direction orthogonal to the orbital direction, and a size of one grid in the width direction corresponds to an observation width of the satellite.

3. The vegetation management system according to claim 2, wherein
the planning unit performs the reinforcement learning by setting a reward with respect to a fact that all grids constituting a row in the orbital direction are in the cleared status before the grids are in the shooting status when the trimming work plan is formulated, and
the planning unit excludes the row in which all the grids are cleared by the trimming work when the sensing plan is formulated.

4. The vegetation management system according to claim 1, wherein
the planning unit performs the reinforcement learning by setting a reward in accordance with a risk determined by analyzing a newly shot satellite image.

5. The vegetation management system according to claim 1, wherein
the reinforcement learning is performed by setting a penalty when the partial region in the shooting status and the partial region in which the trimming work is executed duplicate each other.

6. The vegetation management system according to claim 1, further comprising:
a risk prediction unit configured to diagnose a contact risk, the contact risk being a risk that the vegetation comes into contact with the power transmission facility, by at least one of the number of times of occurrence of a power outage in the past or a satellite image shot in the past, and generate a prediction risk map in which growth over time is reflected in a risk evaluation result, wherein
the planning unit formulates the trimming work plan using the prediction risk map.

7. The vegetation management system according to claim 1, wherein
the planning unit, when a satellite image that is a sensing result is obtained for the partial region in the shooting status, evaluates a risk in a plurality of stages based on the satellite image, and updates the partial region evaluated as having a risk necessary to be cleared by the trimming work to the clear waiting status.

8. The vegetation management system according to claim 7, wherein
the planning unit updates the partial region with a sufficiently low risk to be in the cleared status.

9. The vegetation management system according to claim 3, wherein
the planning unit formulates a plan in which a row having a largest number of grids with a high risk is set as a next new sensing candidate.

10. The vegetation management system according to claim 3, wherein
the planning unit formulates a plan in which a row having a largest number of grids in the clear waiting status is set as a next new sensing candidate.

11. The vegetation management system according to claim 3, wherein
the planning unit formulates a plan in which a row obtained by dividing blocks in which the clear waiting status is continuous is set as a next new sensing candidate.

12. The vegetation management system according to claim 1, wherein
the planning unit adds an error component of a growth prediction model of the vegetation as a risk prediction error when simulating an actual risk determined by the satellite image during the reinforcement learning.

13. The vegetation management system according to claim 1, further comprising:
an output unit configured to output the trimming work plan formulated based on the sensing plan and the sensing plan formulated based on the trimming work plan.

14. A vegetation management method for managing vegetation around a power transmission facility, the vegetation management method comprising:
performing, by a vegetation management system
an acquisition step of acquiring at least a satellite image of a power transmission line arrangement region;
a site work situation collection step of collecting a situation of a trimming work executed at a site of the power transmission line arrangement region;
a planning step of dividing the power transmission line arrangement region into a plurality of partial regions, managing a status relating to a trimming work and the acquisition of the satellite image in association with each of the partial regions, and formulating a trimming work plan and a satellite image sensing plan based on the status; and
an update step of updating the trimming work plan and the satellite image sensing plan by reflecting the situation of the trimming work executed at the site of the power transmission line arrangement region, wherein
the status includes a non-shooting status in which the satellite image is not shot, a shooting status in which the satellite image is waiting to be acquired, a clear waiting status in which it is evaluated that there is a risk necessary to be cleared by executing the trimming work, and a cleared status indicating that the risk is cleared regardless of whether the satellite image is shot, and
the planning step and the update step acquire an order of executing the trimming work on the plurality of partial regions by training an agent, an action of the agent being along a direction of progress of handling a risk by trimming, with reinforcement learning based on statuses of the plurality of partial regions.
